(19) United States
(12) Patent Application Publication
(10) Pub. No.: US 2011/0317456 A1
(43) Pub. Date: Dec. 29, 2011

(54) OPTIMUM STRUCTURE FOR CHARGE PUMP CIRCUIT WITH BIPOLAR OUTPUT

(76) Inventors: Tang-Kuei TSENG, Hsinchu County (TW); Ryan Hsin-Chin, Taipe City (TW)

(21) Appl. No.: 13/223,514

(22) Filed: Sep. 1, 2011

Related U.S. Application Data
(63) Continuation-in-part of application No. 12/113,266, filed on May 1, 2008.

(51) Int. Cl. H02M 7/00

(52) U.S. Cl. 363/60

(57) ABSTRACT

A charge pump circuit with bipolar output comprises six switches, one transfer capacitor, two storage capacitors and a power source. The gate of the switches have been provided an input voltage collocated with clock signals to control the turn-on time of the switches in order to adjust the level of the output voltage and thus produce bipolar voltage output. The clock signals have been selectively driven by a four-phase signal so as to produce bipolar voltages with magnitudes higher than the input voltage with minimum number of switches and capacitors and also accomplish the highest efficiency.

### RELATED APPLICATIONS

The present invention is a continuous-in-part application of the application that is entitled “OPTIMUM STRUCTURE FOR CHARGE PUMP CIRCUIT WITH BIPOLAR OUTPUT” (U.S. application Ser. No. 12/113,266), which is filed presently with the U.S. Patent & Trademark Office, and which is used herein for reference in its entirety.

### BACKGROUND OF THE INVENTION

1. Field of the Invention

The present invention relates to a charge pump and, more particularly, to a charge pump circuit with bipolar output that includes minimum number of capacitors and switches and can be applied to existent CMOS IC fabrication processes.

2. Description of Related Art

With the development of the manufacturing process, the size and operating voltage of components become smaller. However, the transmission voltages of I/O signals usually are higher than those of internal circuits or applied voltages. Therefore, it is necessary to design a DC voltage conversion circuit in an IC to provide a voltage source with a voltage higher than the applied voltage. Charge pump circuit is one of the DC voltage conversion circuit.

Because the charge pump circuits proposed here have the function of converting a unipolar voltage (+V) to a bipolar voltage output (+/−V) or a bipolar double voltage output (+/−2 V), they can be widely used in ICs, e.g., RS-232 ICs. U.S. Pat. No. 5,306,954 proposed by Sipex Corporation, USA discloses a charge pump circuit with symmetric positive/negative voltage output capability, which is composed of two transfer capacitors, two storage capacitors, and nine switches. The operation of these switches adopts clock signals generated by means of oscillation triggering to drive four-phase switching. Moreover, U.S. Pat. No. 4,999,761 proposed by Maxim Integrated Products, USA discloses an integrated bipolar charge pump power supply and an RS-232 transmitter/receiver, in which a charge pump circuit is composed of two transfer capacitors, two storage capacitors, and eight switches. These switches are driven by two-phase clock signals.

Regardless of what type of charge pump circuits mentioned above, they have the drawbacks of both limited charge conversion efficiency and large ripple of output voltage. In particular, the four-phase switched charge pump circuit proposed by Sipex Corporation, USA has a larger ripple. Moreover, the above-mentioned charge pump circuits include too many capacitors and switches, which increase the total cost and waste the precious design area. Therefore, a charge pump circuit with structure of small size and high efficiency has been proposed here.

Accordingly, the present invention aims to propose a new charge pump circuit structure with minimum number of capacitors and switches in order to solve the above problems in the prior art and create a high-efficiency circuit.

### SUMMARY OF THE INVENTION

An object of the present invention is to provide a charge pump circuit with bipolar output, which comprises minimum number switches and capacitors, and driven with four-phase clock. The proposed new charge pump circuit provides bipolar voltage diminish the total cost and save huge design area in an IC, which meets the requirement for several high voltages application in an IC or I/O interface.

Another object of the present invention is to provide a charge pump circuit with bipolar output, which has the advantages of both high conversion efficiency and smaller ripple of output voltage.

To achieve the above objects, the present invention proposes a new charge pump circuit, which can produce bipolar voltage output based on a single input voltage. This charge pump circuit includes six switches: a first switch, a second switch, a third switch, a fourth switch, a fifth switch and a sixth switch. The first switch selectively connects a first input terminal of a transfer capacitor to a voltage source. The second switch selectively connects a first input terminal of a first storage capacitor to the first input terminal of the transfer capacitor. The third switch selectively connects a second input terminal of the transfer capacitor to the voltage source. The fourth switch selectively connects the second input terminal of the transfer capacitor to a ground terminal. The fifth switch selectively connects the second input terminal of the transfer capacitor to a second input terminal of a second storage capacitor. The sixth switch selectively connects the first input terminal of the transfer capacitor to the ground terminal. These six switches can perform four-phase switching based on clock signals to selectively store charges in the transfer capacitor, the first storage capacitor, and the second storage capacitor so as to provide bipolar voltage output for integrated IC product.

### BRIEF DESCRIPTION OF THE DRAWINGS

The various objects and advantages of the present invention will be more readily understood from the following detailed description when read in conjunction with the appended drawing, in which:

FIG. 1 is a diagram of a charge pump circuit of the present invention;

FIG. 2 is a timing diagram of four-phase control signals used in the circuit of the present invention; and

FIGS. 3(a) to 3(d) are functional diagrams under four phases operation in FIG. 1, respectively.

### DETAILED DESCRIPTION OF THE PREFERRED EMBODIMENTS

The present invention discloses a charge pump circuit with bipolar output, which includes minimum capacitors and switches and can apply to the present CMOS IC process. This charge pump circuit is composed of six switches, three capacitors and a power source, and makes use of four-phase clock signals to produce bipolar voltage higher than the input voltage. The proposed charge pump circuit meets the requirement that several high voltages for circuits in an IC or I/O circuits of an IC needed under the condition of a single power source.

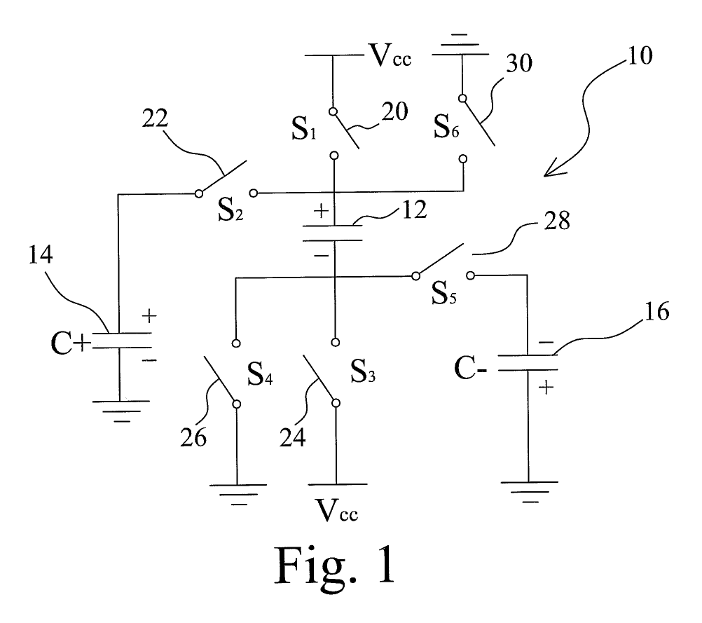

Please refer to FIG. 1. FIG. 1 is a diagram of a charge pump circuit of the present invention. As shown in FIG. 1, a charge pump circuit 10 comprises one transfer capacitor 12(C1), two storage capacitors 14 (C+) and 16 (C−), and six switches 20, 22, 24, 26, 28, 30 (S1˜S6), and provides an input voltage collocated with clock signals to control the turn-on time of the switches in order to adjust the level of the output voltage and thus produce bipolar voltage output. The switch 20 selectively connects the voltage source (Vcc) to the first input terminal (+) of the transfer capacitor 12 (C1). The switch 22 selectively connects the first input terminal (+) of the transfer capacitor 12 (C1) to the first input terminal (+) of the first storage capacitor 14 (C+). The switch 24 selectively connects the second input terminal (−) of the transfer capacitor 12 (C1) to the voltage source (Vcc). The switch 26 selectively connects the second input terminal (−) of the transfer capacitor 12 (C1) to the ground terminal (Gnd). The switch 28 selectively connects the second input terminal (−) of the transfer capacitor 12 (C1) to the second input terminal (−) of the second storage capacitor 16 (C−). The switch 30 selectively connects the first input terminal (+) of the transfer capacitor 12 (C1) to the ground terminal (Gnd). Moreover, the second input terminal (−) of the first storage capacitor 14 (C+) and the first input terminal (+) of the second storage capacitor 16 (C−) are connected to the ground terminal (Gnd).

Please note that, all of the switches 20, 22, 24, 26, 28, and 30 can be realized with semiconductor transistors or bipolar junction transistors (BJTs), e.g., p-type MOS transistors, n-type MOS transistors, or npn or pnp transistors. Moreover, the above ground terminal can be the input of a different voltage source.

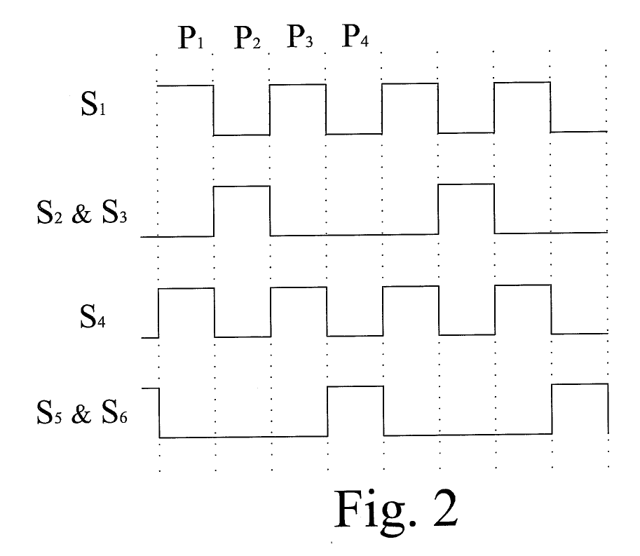

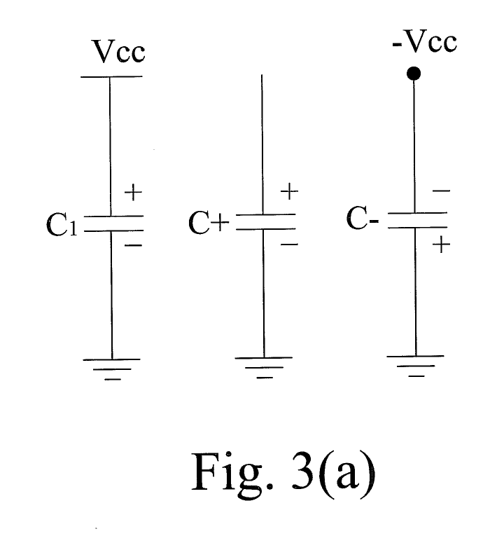

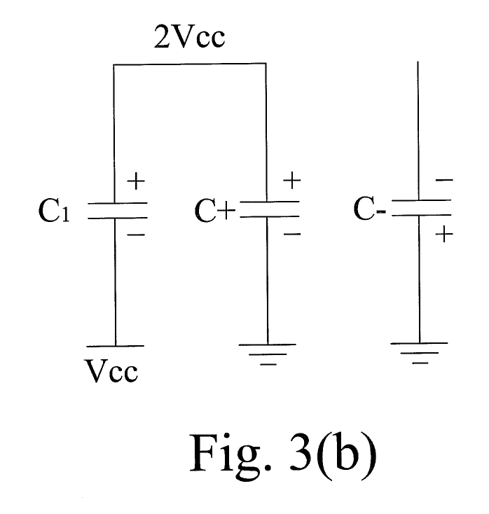

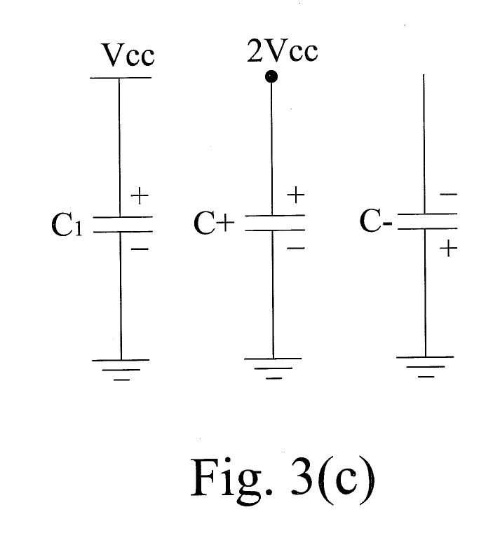

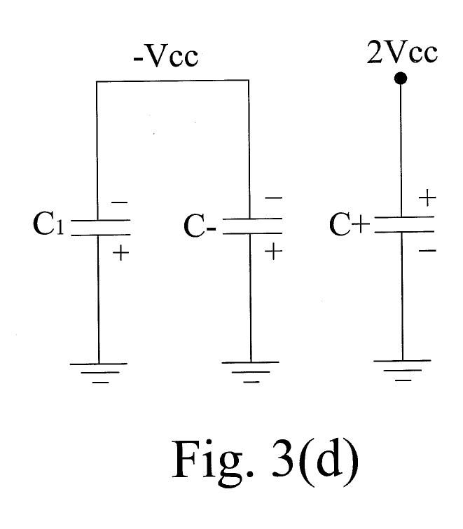

The actions of the switches 20, 22, 24, 26, 28, and 30 are controlled by four phase clock signals generated by a clock generator (not shown). FIG. 2 is a timing diagram of four-phase control signals used in the circuit of the present invention. Please refer to FIG. 1 as well as FIG. 2. First, at the first phase (P1), the switch 20 (S1) and the switch 26 (S4) are enabled while the switch 22(S2), the switch 24 (S3), the switch 28 (S5), and the switch 30 (S6) are disabled. That is, at the first phase (P1), the first input terminal (+) of the transfer capacitor 12 (C1) is connected to the voltage source (Vcc) and the second input terminal (−) of the transfer capacitor 12 (C1) is connected to the ground terminal (Gnd). Under ideal conditions, assume the on-resistance of these switches is zero. When the voltage source Vcc charges the transfer capacitor 12 (C1), the voltage on the transfer capacitor 12 (C1) is Vcc, as shown in FIG. 3(a). Next, at the second phase (P2), the switch 20 (S1), the switch 26 (S4), the switch 28 (S5), and sixth switch 30 (S6) are disabled while the switch 22 (S2) and the switch 24 (S3) are enabled to be on state. Please note that, in the present invention, the switch 22 (S2) and the switch 24 (S3) have the same clock signal. At the second phase (P2), the first input terminal (+) of the first storage capacitor 14 (C+) is connected to the first input terminal (+) of the transfer capacitor 12 (C1), and the second input terminal (−) of the transfer capacitor 12 (C1) is connected to the voltage source Vcc. Accordingly, the voltage source Vcc is applied on the second input terminal (−) of the transfer capacitor 12 (C1) to produce a voltage of 2 Vcc at the first input terminal (+) of the transfer capacitor 12 (C1), and charge sharing is then happened with the first storage capacitor 14 (C+), as shown in FIG. 3(b). That is, the positive double voltage (2 Vcc) can be produced at this second phase (P2) after several clock cycle in ideal case.

At the third phase (P3), the switch 22 (S2), 24 (S3), 28 (S5), and the switch 30 (S6) are disabled while the switch 20 (S1) and the switch 26 (S4) are enabled to be on state. At this time, the transfer capacitor 12 (C1) is reconnected to the voltage source (Vcc) and the ground terminal (Gnd). The voltage source Vcc charges the transfer capacitor 12 (C1) to a voltage of Vcc again, as shown in FIG. 3(c). Finally, at the fourth phase (P4), the switch 20 (S1), 22 (S2), 24 (S3) and 26 (S4) are disabled while the switch 28 (S5) and the switch 30 (S6) are enabled to be on state. At this time, the second input terminal (−) of the second storage capacitor 16 (C−) is connected to the second input terminal (−) of the transfer capacitor 12 (C1), and the first input terminal (+) of the transfer capacitor 12 (C1) is connected to the ground terminal (Gnd). Accordingly, the ground terminal (Gnd) is connected on the first input terminal (+) of the transfer capacitor 12 (C1) to produce a voltage of −Vcc at the second input terminal (−) of the transfer capacitor 12 (C1), and charge sharing is then happened with the second storage capacitor 16 (C−), as shown in FIG. 3(d). That is, the negative voltage (−Vcc) can be produced at this fourth phase (P4) after several clock cycle in ideal case.

In contrast to the related charge pump circuit, the present invention proposes a high-efficiency charge pump circuit with minimum electronic devices (e.g. switches and capacitors). The charge pump circuit in the present invention includes only three capacitors and six switches to output the bipolar voltages under four-phase driven, which diminishes the total cost and saves huge design area in IC. Moreover, the present invention has high performance and low cost design. Therefore, the present invention has many economic benefits.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A charge pump circuit with bipolar output producing bipolar output voltages based on an input voltage, said charge pump circuit comprising:
a first switch selectively connecting a first input terminal of a transfer capacitor to a voltage source;
a second switch selectively connecting a first input terminal of a first storage capacitor to said first input terminal of said transfer capacitor;
a third switch selectively connecting a second input terminal of said transfer capacitor to said voltage source;
a fourth switch selectively connecting said second input terminal of said transfer capacitor to a ground terminal;
a fifth switch selectively connecting said second input terminal of said transfer capacitor to a second input terminal of a second storage capacitor; and
a sixth switch selectively connecting said first input terminal of said transfer capacitor to said ground terminal.

2. The charge pump circuit with bipolar output as claimed in claim 1, wherein a second input terminal of said first storage capacitor connects to said ground terminal.

3. The charge pump circuit with bipolar output as claimed in claim 1, wherein a first input terminal of said second storage capacitor connects to said ground terminal.

4. The charge pump circuit with bipolar output as claimed in claim 1, wherein all of said first switch, said second switch, said third switch, said fourth switch, said fifth switch, and said sixth switch are composed of semiconductor transistors or bipolar junction transistors (BJTs).

5. The charge pump circuit with bipolar output as claimed in claim 1 further comprising a clock generator, wherein said clock generator produces a plurality of clock signals to control actions of said first switch, said second switch, said third switch, said fourth switch, said fifth switch, and said sixth switch, respectively.

6. The charge pump circuit with bipolar output as claimed in claim 5, wherein said first switch, said second switch, said third switch, said fourth switch, said fifth switch, and said sixth switch are controlled by four-phase switching.

7. The charge pump circuit with bipolar output as claimed in claim 6, wherein actions of said first switch, said second switch, said third switch, said fourth switch, said fifth switch, and said sixth switch comprise the steps of:
at a first phase, enabling said first switch and said fourth switch, and disabling said second switch, said third switch, said fifth switch and said sixth switch to let said voltage source (Vcc) charge said transfer capacitor;
at a second phase, enabling said second switch and said third switch, and disabling said first switch, said fourth switch, said fifth switch and said sixth switch to let said voltage source (Vcc) act on said transfer capacitor and said first storage capacitor;
at a third phase, enabling said first switch and said fourth switch, and disabling said second switch, said third switch, said fifth switch and said sixth switch to let said voltage source (Vcc) charge said transfer capacitor; and
at a fourth phase, enabling said fifth switch and said sixth switch, and disabling said first switch, said second switch, said third switch and said fourth switch to let said voltage source (Vcc) act on said transfer capacitor and said second storage capacitor.

8. The charge pump circuit with bipolar output as claimed in claim 6, wherein said second switch and said third switch have same clock signal.

9. The charge pump circuit with bipolar output as claimed in claim 1, wherein the output voltage of said charge pump circuit is controlled between |Vcc| and 2 |Vcc| and up to 2 |Vcc| by controlling a turn-on time of said first switch, said second switch, said third switch, said fourth switch, said fifth switch and said sixth switch.

10. The charge pump circuit with bipolar output as claimed in claim 1, wherein said ground terminal is further connected to another voltage source.

11. The charge pump circuit with bipolar output as claimed in claim 1, wherein said first input terminal of said transfer capacitor, said first input terminal of said first storage capacitor, and said first input terminal of said second storage capacitor are positive electrode terminals.

12. The charge pump circuit with bipolar output as claimed in claim 1, wherein said second input terminal of said transfer capacitor, said second input terminal of said first storage capacitor, and said second input terminal of said second storage capacitor are negative electrode terminals.
